(19) United States
(12) Patent Application Publication
(10) Pub. No.: US 2007/0204085 A1
(43) Pub. Date: Aug. 30, 2007

(54) Method of processing nonsecure interrupts by a processor operating in the secure mode, associated processor

(75) Inventors: William Orlando, Peynier (FR); Christian Schwarz, Aix en Provence (FR)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMicroelectronics S.A., Montrouge (FR)

(21) Appl. No.: 11/405,269

(22) Filed: Apr. 17, 2006

(30) Foreign Application Priority Data
Apr. 18, 2005 (FR) 05 03867

(51) Int. Cl. G06F 13/24

(52) U.S. Cl. 710/261

(57) ABSTRACT

A method of processing interrupts in a processor adapted for operating either in a first mode, or in a second mode, and having at least one counter comprises the following, when an interrupt associated with an interrupt subroutine executable in the second mode is dispatched to the processor in the course of the execution of a process by the said processor in the first mode, at least the counter is initialized to a start value; then the counter is started while the processor is toggled into the second mode to execute the interrupt subroutine associated with the interrupt; when the counter reaches an end value, the processor is returned to the first mode for the continuation of the execution of the process.

### TECHNICAL FIELD

The present disclosure generally but not exclusively relates to the field of processors adapted for processing applications requiring different security levels. Such processors are for example used in devices of the portable telephone, PDA, TV decoder (otherwise known as set top box) type, etc. On such processors are executed applications without any particular security requirement and applications manipulating sensitive information pertaining for example to authentication, to encryption, or else manipulating personal data, etc, to which it is not desirable to give unrestricted access.

### BACKGROUND INFORMATION

It is desirable to be able to continue to execute a pre-existing operating system (“Legacy OS”) such as Windows® or Linux®, and its associated application routines, while being able to control them in such a way as not to jeopardize the integrity and the security of the system were a hacker to take control of the OS by utilizing flaws.

A tendency observed in the state of the art involves favoring an essentially hardware approach for attaining a certain level of security. According to such an approach, additional hardware means make it possible to isolate and therefore to protect a so-called secure domain inside the processor, by ensuring hardware-wise the separation between the secure domain and a so-called nonsecure domain. The isolation involves preventing access to the resources (memories, peripherals) of the secure domain by the processor or by peripherals capable of reading/writing when they are not authorized to operate in the secure domain (processor in nonsecure mode or else DMA controllers for example).

This approach is in particular used in products based on the Trustzone™ technology from ARM. Reference may in particular be made to the documents “TrustZone: Integrated Hardware and Software Security, Enabling Trusted Computing in Embedded Systems” by Tialgo Alves and Don Felton, July 2004.

This type of approach is accompanied by the addition of a security bit or “S-bit”. This S-bit makes it possible to identify the parts of the system which belong to the secure domain. A respective S-bit is associated with the processor core, with the memory, with the units peripheral to the processor, etc. In a general manner, the memory areas and the applications are declared permanently either secure or nonsecure and the hardware modules may be permanently secure and nonsecure or alternatively secure or nonsecure.

### BRIEF SUMMARY OF THE INVENTION

Embodiments of the present invention provide a method and a processor making it possible to toggle the processor from the secure mode to the nonsecure mode upon the receipt of at least certain nonsecure interrupts, and to guarantee the return of the processor from the nonsecure mode to the secure mode.

For this purpose, according to a first aspect, the invention proposes a method of processing interrupts in a processor adapted for operating either in a first mode, or in a second mode, and having at least one counter, said method comprising, when an interrupt associated with an interrupt subroutine executable in the second mode is dispatched to the processor in the course of the execution of a process by the said processor in the first mode,
the counter is initialized to a start value; then
the counter is started while the processor is toggled into the second mode to execute the interrupt subroutine;
when the counter reaches an end value, the processor is returned to the first mode for the continuation of the execution of the process.

In a mode of embodiment of the invention, the first mode is the secure mode and the second mode is the nonsecure mode.

An embodiment of the present invention thus makes it possible to satisfy real time constraints of applications of the nonsecure domain, and thus to improve the reactivity of the system, while ensuring the return to the secure domain, and hence the continuation of the processing in secure mode of the interrupted process.

An embodiment of the invention makes it possible to avoid calling upon a specific mode operating in tandem on both domains.

In an embodiment, the counter is a time counter. It indicates a time elapsed since the starting of the counter. The end value is a maximum time.

In another embodiment, the counter of the processor is an interrupt counter. It counts the number of interrupts to be processed by the processor and which are associated with an interrupt subroutine executable in the second mode. This counter is started upon the receipt of the first of these interrupts causing the switch from the first mode to the second mode. It is successively incremented upon the receipt of a new interrupt associated with an interrupt subroutine executable in the second mode by the processor while this latter processes a previous interrupt received. The counter is decremented once the processing of one of these interrupts has terminated.

In one embodiment, when a determined interrupt to be processed associated with an interrupt subroutine executable in the second mode arises in the course of an execution of a process in the first mode, an interrupt counter and a time counter are both initialized and started before toggling into the second mode. Also the processor is toggled into the first mode when the first of the two counters has reached its associated end value. This arrangement therefore makes it possible to return to the first mode as soon as the subroutines are processed and furthermore makes provision for a “watchdog” preventing a malicious application from detaining the processor for too long in the second mode.

The end value associated with the interrupt counter is representative of a zero number of nested interrupts remaining to be processed by the processor. Typically, this value will be zero, but various increment, decrement and end values may be used.

According to a second aspect, the invention proposes a processor adapted for operating either in a first mode, or in a second mode and comprising:

a counter;

initialization means for, when an interrupt associated with an interrupt subroutine executable in the second mode is dispatched to the processor in the course of the execution of a process by the said processor in the first mode, initializing the said counter to a start value and starting the said counter;

first toggling means for, upon the starting of the counter, causing the toggling of the processor into the second mode for the execution, in the second mode, of the interrupt subroutine;

second toggling means for, when the counter reaches an end value, returning the processor to the first mode.

### BRIEF DESCRIPTION OF THE SEVERAL VIEWS OF THE DRAWINGS

Other characteristics of one or more embodiments of the invention will become further apparent on reading the description which follows. The latter is purely illustrative and should be read in conjunction with the appended drawings in which:

FIG. 1 is a diagram representing various modules of a processor in an embodiment of the invention;

FIG. 2 is a diagram representing the operations of a processor according to one embodiment of the invention in the secure and nonsecure modes and the switchovers from one to the other; and

FIG. 3 is a diagram representing the operations of a processor according to one embodiment of the invention in the secure and nonsecure modes and the switchovers from one to the other.

### DETAILED DESCRIPTION

Embodiments of a method of processing nonsecure interrupts by a processor operating in the secure mode, and an associated processor, are described herein. In the following description, numerous specific details are given to provide a thorough understanding of embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

One embodiment of the present invention relates to processors in which a hardware separation between a secure domain and a nonsecure domain is implemented and is most especially but not exclusively concerned with the processing of interrupts by such processors.

An interrupt is a command indicating that the routine currently undergoing processing should be interrupted in favor of a subroutine to be executed (“Interrupt Service Routine”).

Conventionally, when the processor executes a process in the secure domain (one then speaks of “secure mode” of the processor) and when an interrupt arises, the interrupt is filtered by an interrupt controller of the processor. If the interrupt subroutine associated with the said interrupt is executable in the nonsecure domain, this interrupt is not then delivered by the interrupt controller to the processor for execution. Thus, the executions in the secure domain are generally not interrupted to execute applications in the nonsecure domain.

It may, however, turn out to be desirable, in order to satisfy the constraints of speed of processing of real time applications executable in the nonsecure domain, to authorize the execution of such a subroutine and thus to interrupt the execution of the process in secure mode. Interruption of the secure routine is accompanied by the saving of the (secure) context data of the interrupted process so as to allow the resumption of the process in secure mode as soon as possible.

When the processor is in the nonsecure domain and when the processor configuration pertaining to the separation of the secure and nonsecure domains is such that upon the execution of an interrupt in nonsecure mode, no data pertaining to the secure domain is then accessible to it, the processor does not have access to the information according to which a process in secure mode has been interrupted and must be resumed.

Now, it is necessary to be able to return as soon as possible to the secure mode so as to complete the execution of the interrupted process. In particular, it is desirable to protect oneself from so-called malicious applications which would cause successive interrupts pertaining to subroutines executable in the nonsecure domain, and which would thus prevent return to the secure mode.

In the processors of the prior art associated with a hardware separation between a secure domain and a nonsecure domain, no provision is made for a mechanism making it possible, once the processor has toggled into the nonsecure mode so as to process an interrupt, to cause the reverse toggling, nor making it possible to protect oneself from malicious applications such as these.

Hereinbelow, the applications executable in the secure domain will be dubbed succinctly: “secure application”, the applications executable in the nonsecure domain: nonsecure application”. In the same way, the interrupts pertaining to subroutines executable in the secure domain will be dubbed “secure interrupts” and the interrupts pertaining to subroutines executable in the nonsecure domain: “nonsecure interrupts”.

The document U.S. Patent Publication No. 2004/0153,672 (ARM) teaches that when a nonsecure interrupt arises while the processor is operating in secure mode, the toggling from the secure mode to the nonsecure mode is effected by way of a specific software module executing in a specific additional mode called the monitor mode, which manages the transitions while storing events pertaining to the nonsecure domain and also to the secure domain. The processor then executes the interrupt subroutine in the nonsecure mode. The toggling from the nonsecure mode to the secure mode is effected thereafter by way of another specific software module executing in the monitor mode.

Embodiments of the present invention address the various disadvantages of known processing systems and techniques described above.

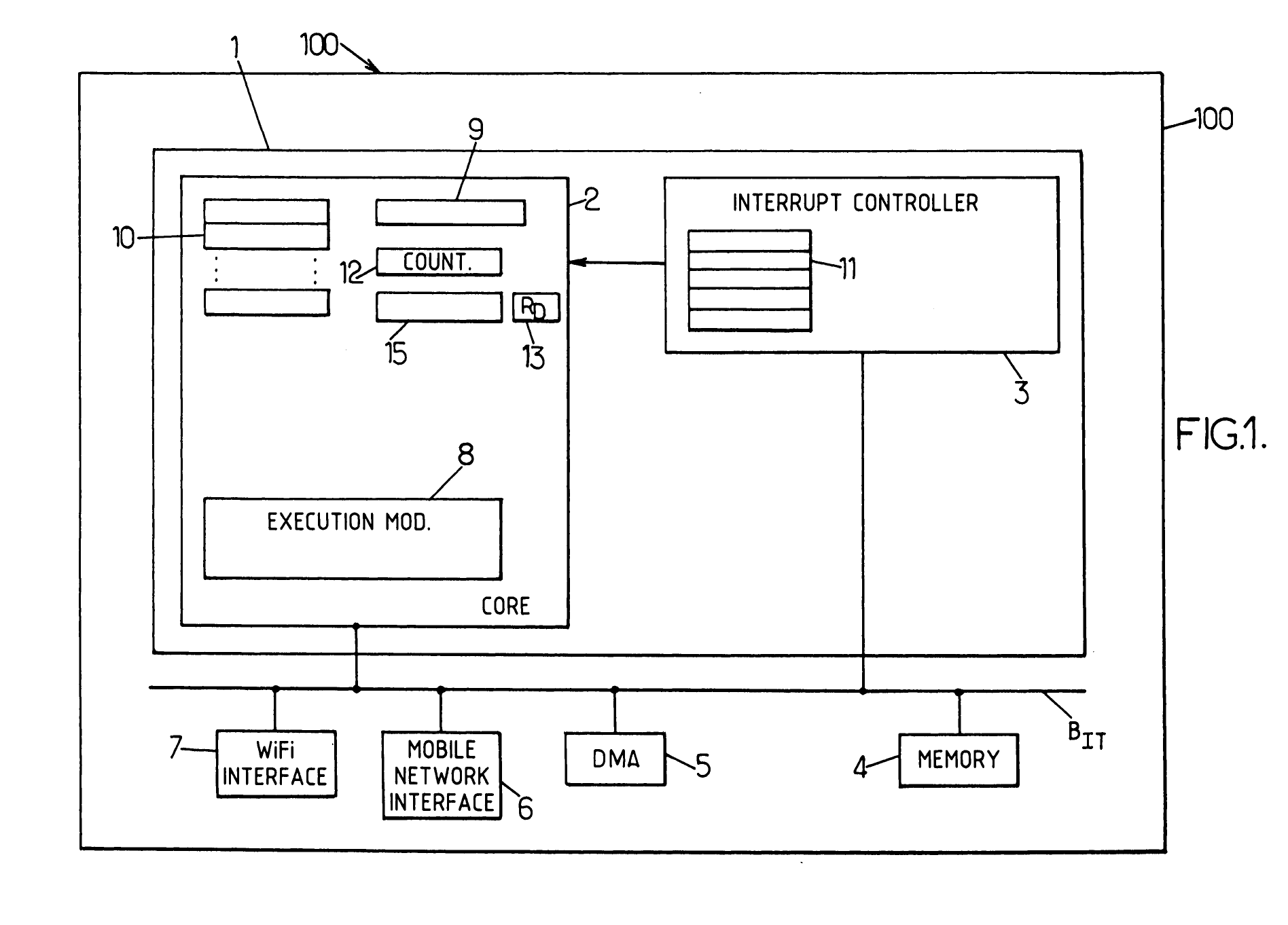

Represented diagrammatically in FIG. 1 is a device 100 according to an embodiment of the present invention. This device 100 comprises a processor 1. This processor 1 comprises a processor core 2 and an interrupt controller 3. The processor 1 is linked to a memory 4 and to a plurality of units external to the processor, three of which have been represented in FIG. 1. These peripheral units are of very diverse nature. Unit 5 is for example a DMA controller. Unit 6 is for example an interface device with a mobile telephone network. Unit 7 is an interface device with a local area network, for example of WiFi type implementing operations of encryption, etc.

The device 100 implements the hardware security approach presented above.

The processor 1 in particular is adapted for working either in a secure mode, or in a nonsecure mode.

The secure resources (modules, applications, data, registers) are not accessible by nonsecure resources, this distinction between the two domains being ensured by hardware means.

The core 2 of the processor 1 comprises an execution module 8, a mode register 9, and a plurality of operating registers 10. The processor core 2 according to an embodiment of the invention furthermore comprises a counter 12.

The counter 12 is associated with a start register 13 comprising a predefined value dubbed the start value R_{D}.

The interrupt controller 3 comprises interrupt registers 11.

The value taken by the mode register 9 indicates the mode in which the processor is currently operating. If this value is equal to the S-bit, in the case considered equal to 1, the processor operates in the secure mode, otherwise in the nonsecure mode, the value of the mode register then being equal to 0.

The execution module 8 is adapted for processing the instructions of the routines during their execution by the processor core 2. The processing by the execution module 8 of a secure application begins with the toggling of the processor into the secure mode, if it was not already in this mode. Then the secure resources may be accessed.

Conversely, the processing by the execution module 8 of a nonsecure application causes the toggling of the processor into the nonsecure mode, if it was not already in this mode. Then only the nonsecure resources may be accessed.

The switchover to the secure mode causes the recording, by the execution module 8, in the mode register 9, of the bit of value 1 (S-bit). And the switchover into the secure mode causes the recording, by the execution module 8, in the mode register 9, of the bit of value 0.

The interrupt controller 3 is adapted for receiving, by way of an interrupt bus B_{IT}, the interrupts originating from all the peripheral units. It is furthermore adapted for selectively presenting the interrupts received to the processor core 2.

The registers 11 of the interrupt controller 3 comprise data indicating the address of the interrupt subroutine associated with each interrupt. These data are also called interrupt vectors.

The interrupt vector of an interrupt selected by the interrupt controller is provided to the execution module 8, for the execution of the interrupt subroutine.

Generally, an interrupt controller of the prior art is adapted for, when the processor is currently executing a process in the secure mode, considering only the interrupts pertaining to secure interrupt subroutines. Only the registers 11 pertaining to the secure interrupts are then taken into account by the controller. Further criteria for selection may moreover be used to filter the interrupts to be presented to the processor core. All of these criteria defining the filter applied are contained in the registers 11 of the interrupt controller 8. These criteria are dubbed interrupt masks. They make it possible to select the interrupts to be presented for example as a function of the context (as a function of the process currently executing, etc.).

Moreover, generally, a secure interrupt arising while a nonsecure application is being executed by the processor core 2 is transmitted by the interrupt controller 3 to the processor core for processing. It causes the toggling of the processor 1 into secure mode so as to process the secure interrupt subroutine associated with the interrupt.

In a conventional manner, when the execution of an interrupt subroutine is completed, an event occurs, indicating this end of processing, for example an instruction of “End of Interrupt” type is executed.

In the embodiment of the invention, it is furthermore decided, with respect to the operation of a processor of the prior art, that certain at least of the nonsecure interrupts may interrupt the execution of certain at least of the secure processes.

The secure processes thus considered as interruptible by certain nonsecure interrupts are for example processes whose execution time is long.

The nonsecure interrupts thus considered as being able to interrupt certain of the secure processes are for example associated with subroutines subject to heavy time constraints (real time applications).

According to an embodiment of the invention, in order to allow these chosen nonsecure interrupts to be able to interrupt determined secure processes, these interrupts are declared secure. They are then considered by the interrupt controller 3 when they arise while the processor core 2 is operating in the secure mode. The interrupt registers 11 pertaining to these interrupts and comprising the interrupt vectors and masks are then accessible to the interrupt controller 3 when the processor is in the secure mode. Moreover, the interrupt masks are supplemented to indicate which secure processes will be able to be interrupted by each of these interrupts.

For example the application A performing data integrity checks using an SHA-1 encryption algorithm (Secure Hash Algorithm) is an application regularly executed in the processor 100.

Now, the execution time of this application is relatively long.

Moreover, it is desirable to rapidly process the nonsecure interrupts I_{RT} emitted on the interrupt bus B_{IT} by the interface device 6 for interfacing with a mobile telephone network, upon the receipt by this device of a data packet originating from the telephone network.

It is, according to one embodiment of the invention, decided that if a nonsecure interrupt I_{RT} such as this occurs during the execution of the application A by the processor core 2, the execution of the application A will be suspended so as to execute the nonsecure interrupt subroutine SP_{RT} associated with the interrupt I_{RT}. The registers 11 comprising the interrupt masks and interrupt vectors pertaining to the interrupt I_{RT} are therefore declared as secure (they are associated with the S-bit) and the interrupt mask is updated to allow the interruption of the application A by the interrupt I_{RT}.

According to an embodiment of the invention, when the secure application A is executed by the processor core 2, and when the interrupt controller 3 receives by way of the interrupt bus B_{IT}, an interrupt I_{RT}, the controller 3 presents to the processor core 2 data comprising the interrupt vector pertaining to the interrupt I_{RT} providing the data necessary for the execution of the interrupt subroutine SP_{RT}.

On receipt of the nonsecure interrupt I_{RT} during the execution of the secure application A, the processor core 2 is adapted for previously executing a secure application APPᵣₑₜ for preparing the return to the secure mode, hereinafter dubbed the “return application”.

This return application APPᵣₑₜ firstly comprises instructions for saving the state of the processor in the operating registers 10, so as to be able to resume the execution of the process A interrupted in the state that it was in at the time that the interrupt I_{RT} was taken into account.

The return application APPᵣₑₜ furthermore comprises instructions for initializing the counter 12 to the value stored in the start register R_{D}.

The return application APPᵣₑₜ finally comprises instructions for starting the counter 12, that is to say activating the counting logic, and causing the toggling of the processor 1 into the nonsecure mode, the value of the mode register 9 associated with the processor 1 then being set to 0. The execution module 8 then undertakes the execution of the interrupt subroutine SP_{RT}.

The return of the processor 1 to the secure mode is caused when the value of the counter 12 is equal to a predetermined value.

In a particular embodiment of the invention, the counter 12 is a clock register. The start value stored in the start register 13 is equal to Tmax (for example equal to the mean processing time of three nonsecure interrupts). Thus once started, the counter 12 is decremented as time proceeds (as a function of a clock managing the timing of the counter 12).

The counter 12 is configured to emit a secure interrupt I_{S} once it has reached the value 0.

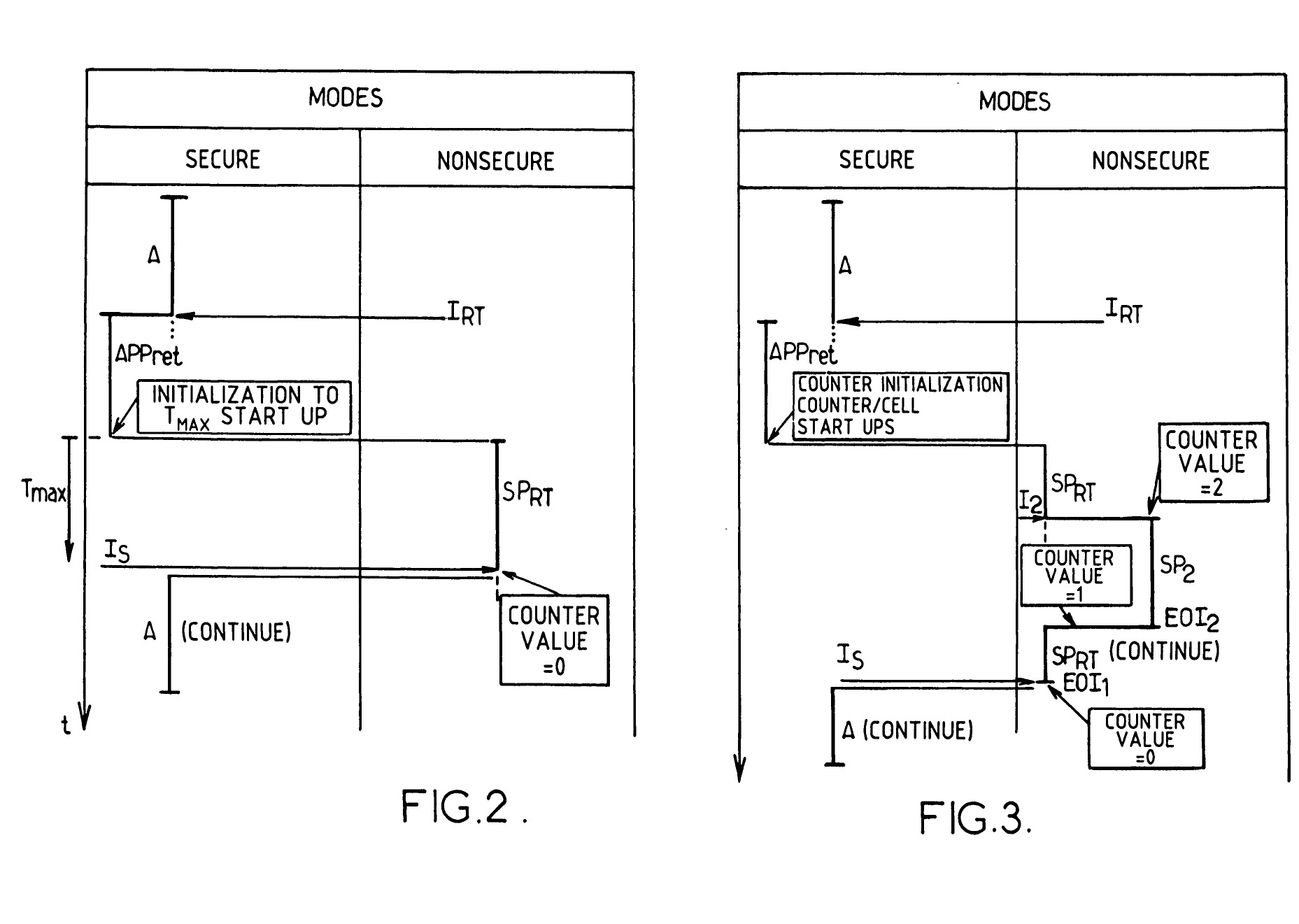

FIG. 2 illustrates the successive executions over time (vertical axis) by the processor 1 of the various applications called, in this embodiment of the invention, in the secure mode or in the nonsecure mode, as well as the switchovers from one to the other of these modes.

Thus, as illustrated in FIG. 2, on receipt of the nonsecure interrupt I_{RT} during the execution of the secure application A the processor core 2 is adapted for previously executing the secure return application APPᵣₑₜ, which causes the saving of the state of the processor 1 in the operating registers 10 and which initializes the counter 12 with the value R_{D}=Tmax stored in the start register 13. The application APPᵣₑₜ starts the counter 12 and causes the toggling of the processor 1 into the nonsecure mode, the value of the mode register 9 associated with the processor 100 then being set to 0.

The execution module 8 then undertakes the execution of the interrupt subroutine SP_{RT}.

When the value of the counter 12 reaches 0, the counter is adapted for then emitting a secure interrupt I_{S}.

When this secure interrupt I_{S} is received by the interrupt controller 3 by way of the interrupt bus B_{IT}, it transmits it to the processor core 2, thereby causing the return to secure mode (the processor being configured, as indicated above, in a conventional manner so that the arising of a secure interrupt during a nonsecure execution causes a return to the secure mode).

Advantageously, the counter is for example a reloadable monitoring circuit of “watchdog” type, for example of the type implemented in the ST62T20C microcontrollers from STMicroelectronics (to within the variant that the arrival of the counter does not cause a reset, but a secure interrupt).

Such an embodiment makes it possible to compel the processor to return to the secure mode, independently of the events which may arise (for example the receipt of further nonsecure interrupts during the execution of the interrupt subroutine SP_{RT}).

In another particular embodiment of the invention, the counter 12 is a counter of nested interrupts. In this embodiment, the processor core 2 furthermore comprises a control hardware cell 15 associated with the interrupt counter 12.

This hardware cell 15 receives an activation signal for the application APPᵣₑₜ upon the receipt of the first of these interrupts causing the switchover from the secure mode to the nonsecure mode.

The interrupt counter 12 and the hardware cell 15 are adapted so that the interrupt counter 12, once started, is incremented, by the hardware cell 15, by one unit each time the interrupt controller 3 presents a new nonsecure interrupt to be processed to the processor core 2. And the interrupt counter 12 is adapted to be decremented by one unit when a nonsecure interrupt subroutine has been executed, for example as soon as an “End Of Interrupt” instruction has to be executed. The interrupt counter thus indicates the number of nonsecure interrupts remaining to be processed by the processor.

The start value R_{D} stored in the start register 13 is equal to 1.

The control hardware cell 15 is adapted furthermore for, once activated, verifying the value of the interrupt counter 12 each time an “End Of Interrupt” (EOI) instruction has occurred and a decrementation of the counter has been carried out, and for, when the value of the counter is 0, causing the return to the secure mode. It is configured for example to then emit a secure interrupt I_{S}.

In this particular embodiment of the invention, with reference to FIG. 3, when the nonsecure interrupt I_{RT} arises during the execution of the secure application A by the processor core 2, the return application APPᵣₑₜ initializes the counter 12 with the aid of the value R_{D}=1, stored in the start register 13. This value then taken by the interrupt counter 12 indicates that a first nonsecure interrupt, in the case considered, the interrupt I_{RT}, has been received and that the associated interrupt subroutine, in this case the subroutine SP_{RT}, must be executed by the processor core 2. The application APPᵣₑₜ furthermore activates the control hardware cell 15 and cause the toggling of the processor 1 into the nonsecure mode.

The execution module 8 then undertakes the execution of the interrupt subroutine SP_{RT}. If the interrupt controller 3 presents, in accordance with its interrupt masks stored in the interrupt registers 11, to the processor core 2 during this execution, a new nonsecure interrupt I₂ to be processed associated with the subroutine SP2, the execution of the interrupt subroutine SP_{RT} associated with the first interrupt is interrupted. The context is saved so as to be able to be recovered and the interrupt counter 12 is incremented by one unit.

The interrupt counter 12 therefore then indicates the value 2, corresponding to the number of interrupt subroutines (SP_{RT} and SP₂) to be executed.

The execution of the interrupt subroutine SP2 of the second interrupt I2 then commences and terminates with the execution of an EOI instruction.

This EOI instruction is detected by the hardware cell 15, which decrements the interrupt counter 12 by one unit (its value is at present 1), then checks the new value of the counter, by comparing it with 0. Here the value being different from 0, the nonsecure execution context pertaining to the interrupted subroutine SP_{RT} is re-established with the aid of the content of the operating registers 10, then the execution of this subroutine is resumed. It terminates with the execution of an EOI instruction, which causes the decrementation by the hardware cell 15 of the interrupt counter by one unit (its value is at present 0), followed by the checking by the control hardware cell 15 of this updated value.

The current value of the interrupt counter 12 being equal to 0, the control hardware cell 15 causes the return of the processor 1 to the secure mode.

This particular embodiment makes it possible to return to the secure mode as soon as the processing of the nonsecure interrupts has finished.

The control hardware cell 15 is for example a state machine associated with a register, the setting of this register to 1 making it possible to activate this state machine.

In one embodiment, the processor comprises two counters. The first of these counters is a counter of clock register type described above associated with a first start register storing a maximum time Tmax. The second of these counters is an interrupt counter of the type described above associated with a start register containing the value 1 and with a control hardware cell 15.

This dual arrangement makes it possible to benefit from the advantages related to each of the two particular embodiments described above. Specifically, the return to the secure mode is effective as soon as one of the counters reaches the value, which is associated with it and which causes the return to the secure mode. It makes it possible in particular to return to the secure mode as soon as the processing of the nonsecure interrupts has terminated, while not permitting a malicious application to obstinately prevent the return to the secure mode by emitting consecutive nonsecure interrupts, since after a predefined time (Tmax), the toggling to the secure mode will be effected.

The processing performed by the processor 1 has been described above with reference to the interrupt I_{RT} intervening during the execution of the application A. The invention may quite obviously be implemented in respect of any nonsecure interrupt chosen during the execution by the processor of any secure application chosen.

One or more embodiments of the present invention applies also in the case where the processor has the capacity to operate in a supervisor mode (accessible chiefly through the OS), and in a user mode, these modes making it possible in particular for the routines in user mode to have access to only certain resources or instructions of the processor, while the routines in supervisor mode have access to all the instructions of the processor and all the registers and resources.

In this case, there exists a secure mode and a nonsecure mode which pertains to each of these supervisor and user modes respectively.

There is therefore a secure and supervisor mode, a secure and user mode, a nonsecure and supervisor mode and a nonsecure and user mode.

Various embodiments of the present invention have been described in relation to particular predefined start, end and/or increment values. The embodiment(s) of the invention may obviously be implemented with values different from those indicated.

The above description of illustrated embodiments, including what is described in the Abstract, is not intended to be exhaustive or to limit the invention to the precise forms disclosed. While specific embodiments and examples are described herein for illustrative purposes, various equivalent modifications are possible within the scope of the invention and can be made without deviating from the spirit and scope of the invention.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

What is claimed is:

1. A method of processing interrupts in a processor adapted for operating either in a first mode, or in a second mode, and having at least one counter, the method comprising when an interrupt associated with an interrupt subroutine executable in the second mode is dispatched to the processor during execution of a process by said processor in the first mode:
initializing the counter to a start value;
starting the counter while the processor is toggled into the second mode to execute the interrupt subroutine associated with the interrupt; and
when the counter reaches an end value, returning the processor to the first mode for continuation of the execution of the process.

2. The method according to claim 1 wherein the counter of the processor is a time counter which indicates a time elapsed since the starting of said counter, and wherein the end value is a maximum time.

3. The method according to claim 1 wherein the counter of the processor is an interrupt counter which indicates a number of nested interrupts to be processed by the processor, said interrupts being associated with respective interrupt subroutines executable in the second mode, the counter once started being incremented by one unit on receipt of each of said interrupts, and said counter once started being decremented by one unit once processing of one of said interrupt subroutines has terminated.

4. The method according to claim 2 wherein when a determined interrupt to be processed associated with the interrupt subroutine executable in the second mode arises during execution of a process in the first mode, an interrupt counter and the time counter are started, the processor being toggled into the first mode as soon as an end value of any one of the counters is reached.

5. The method according to claim 3 wherein the end value of the interrupt counter is representative of a zero number of nested interrupts to be processed by the processor.

6. A processor adapted for operating either in a first mode, or in a second mode and comprising
a counter;
initialization means for, when an interrupt associated with an interrupt subroutine executable in the second mode is dispatched to the processor during execution of a process by said processor in the first mode, initializing the counter to a start value and starting said counter;
first toggling means for, upon the starting of the counter, causing toggling of the processor into the second mode for the execution, in the second mode, of the interrupt subroutine associated with the interrupt; and
second toggling means for, when the counter reaches an end value, returning the processor to the first mode.

7. The processor according to claim 6 wherein the counter comprises a time counter adapted for indicating a time elapsed since the starting of said counter, the end value indicating a maximum time.

8. The processor according to claim 6 wherein the counter comprises an interrupt counter adapted for indicating a number of nested interrupts to be processed that are received by the processor, the counter once started being adapted to be incremented on receipt by the processor of a new interrupt to be processed, and to be decremented upon an end of the processing of the interrupt by the processor.

9. The processor according to claim 7, further comprising an interrupt counter and wherein:
the initialization means are adapted for, when the interrupt to be processed associated with the interrupt subroutine executable in the second mode is received by the processor during execution of the process in the first mode, starting and initializing each counter; and
the second means of toggling are adapted for returning the processor to the first mode as soon as an end value of any one of the counters is reached, for continuation of the execution of the process.

10. The processor according to claim 8 wherein the end value of the interrupt counter is representative of a zero number of nested interrupts to be processed by the processor.

11. A method of processing interrupts in a processor adapted for operating either in a first mode or in a second mode, the processor having at least one counter, the method comprising:
receiving, during execution of a process by said processor in the first mode, an interrupt associated with an interrupt subroutine executable in the second mode;
initializing the counter to a start value and starting the counter;
toggling the processor to operate in the second mode to execute the interrupt subroutine associated with the interrupt;
operating the counter while the processor executes the interrupt subroutine in the second mode; and
if the counter reaches a value, returning the processor to the first mode to continue the execution of the process.

12. The method of claim 11 wherein toggling the processor to operate in the second mode includes switching the processor to operate in a nonsecure mode, and wherein returning the processor to the first mode includes returning the processor to a secure mode.

13. The method of claim 11 wherein operating the counter while the processor executes the interrupt subroutine in the second mode includes counting a time elapsed since the starting of the counter, and wherein the value is a maximum time.

14. The method of claim 11 wherein the counter includes an interrupt counter that indicates a number of nested interrupts to be processed by the processor, the interrupts being associated with respective interrupt subroutines executable in the second mode, the method further comprising:
incrementing the counter, if started, by one unit in response to receipt of each of the interrupts; and
decrementing the counter, if started, by one unit in response to termination of processing of one of the interrupt subroutines.

15. The method of claim 11 wherein the counter comprises a time counter, the processor further having an interrupt counter, the method further comprising:
if the interrupt to be processed associated with the interrupt subroutine executable in the second mode arises during execution of the process in the first mode, starting the interrupt counter and the time counter; and
toggling the processor into the first mode if a value of either one of the counters is reached.

16. A processor adapted to operate either in a first mode or in a second mode, the processor comprising:
a counter;
an initialization unit operatively coupled to the counter to, if an interrupt associated with an interrupt subroutine executable in the second mode is dispatched to the processor during execution of a process by the processor in the first mode, initialize the counter to a start value and to start the counter;
a first toggling feature operatively coupled to the processor to, in response to the start of the counter, cause toggling of the processor into the second mode to execute, in the second mode, the interrupt subroutine associated with the interrupt; and
a second toggling feature operatively coupled to the processor to, if the counter reaches a value, return the processor to the first mode.

17. The processor of claim 16 wherein the first mode includes a secure mode and wherein the second mode includes a nonsecure mode.

18. The processor of claim 16, further comprising a mode register having a value that can be stored therein that is indicative of whether the processor is in the first mode or the second mode.

19. The processor of claim 16 wherein the counter includes a time counter, the processor further comprising an interrupt counter, wherein if the interrupt to be processed associated with the interrupt subroutine executable in the second mode arises during execution of the process in the first mode, the initialization unit is coupled to start the interrupt counter and the time counter, and wherein the second toggling feature is operatively coupled to toggle the processor into the first mode if an end value of either one of the counters is reached.

20. The processor of claim 16 wherein the counter includes an interrupt counter that indicates a number of nested interrupts to be processed by the processor, the interrupts being associated with respective interrupt subroutines executable in the second mode, the counter being adapted to be incremented by one unit in response to receipt of each of the interrupts, and the counter being adapted to be decremented by one unit in response to termination of processing of one of the interrupt subroutines.

21. The processor of claim 16 wherein the counter includes a time counter operable to count time elapsed since the starting of the counter, and wherein the value is a maximum time.

22. A system, comprising:
a secure domain having associated secure resources;
a nonsecure domain having associated nonsecure resources;
a hardware separation between the secure and nonsecure domains;
a processor coupled to the secure and nonsecure resources, the processor being adapted to switchably operate either in a first mode to execute operations associated with the secure resources or in a second mode to execute operations associated with the nonsecure resources;
a counter associated with the processor;
an initialization unit operatively coupled to the counter to, if an interrupt associated with an interrupt subroutine executable in the second mode is dispatched to the processor during execution of a process by the processor in the first mode, initialize the counter to a start value and to start the counter; and
a switch feature operatively coupled to the processor to, in response to the start of the counter, switch the processor into the second mode to execute, in the second mode, the interrupt subroutine associated with the interrupt, the switch feature further being operatively coupled to the processor to, if the counter reaches a certain value, switch the processor back to the first mode.

23. The system of claim 22 wherein the counter comprises part of the processor.

24. The system of claim 22 wherein the counter comprises a time counter, the system further comprising an interrupt counter associated with the processor, wherein if either the time counter or the interrupt counter reaches respective certain values, the switch feature is operable to switch the processor back to the first mode.
